(19) United States
(12) Patent Application Publication
(10) Pub. No.: US 2008/0246171 A1
(43) Pub. Date: Oct. 9, 2008

(54) CHILLED INJECTION MOLDING DURING OPHTHALMIC LENS MANUFACTURE

(76) Inventors: Gregory L. Berckmiller, Jacksonville, FL (US); Vincent H. Barre, Jacksonville, FL (US); Timothy P. Freeman, Jacksonville, FL (US); Scott F. Ansell, Jacksonville, FL (US); Changhong Yin, St. Augustine, FL (US); Jason M. Tokarski, Jacksonville, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/843,405

(22) Filed: Aug. 22, 2007

Related U.S. Application Data
(60) Provisional application No. 60/827,176, filed on Sep. 27, 2006.

(51) Int. Cl. B29D 11/00

(52) U.S. Cl. 264/1.32; 425/344; 264/2.5

(57) ABSTRACT

The present invention includes molds for forming ophthalmic lenses, such as contact lens. In particular, the present invention relates to apparatus, molds and methods for fashioning mold parts used to fashion an ophthalmic lens which includes cooling a mold structure used to fashion a mold part prior to depositing a molten material into the mold structure.

### RELATED APPLICATIONS

This application claims priority to Provisional Application U.S. Ser. No. 60/827,176, filed Sep. 27, 2006.

### FIELD OF THE INVENTION

This invention relates to molds for forming an ophthalmic lens. More specifically, the present invention relates to apparatus and methods for fashioning a plastic ophthalmic lens mold with reduced injection molding temperatures.

### BACKGROUND OF THE INVENTION

Ophthalmic lenses are often made by cast molding, in which a monomer or prepolymer material is deposited in a cavity defined between optical surfaces of opposing mold parts. Multi-part molds used to fashion hydrogels into a useful article, such as an ophthalmic lens, can include for example, a first mold part with a convex portion that corresponds with a back curve of an ophthalmic lens and a second mold part with a concave portion that corresponds with a front curve of the ophthalmic lens. In this discussion, a first mold part generally refers to a front curve mold part and the second mold part generally refers to a back curve mold part.

To prepare a lens using such mold parts, an uncured hydrogel lens formulation or prepolymer is placed between the concave and convex surfaces of the mold portions and subsequently cured. The hydrogel lens formulation may be cured, for example by exposure to either, or both, heat and light. The cured hydrogel or prepolymer forms a lens according to the dimensions of the mold portions.

Following cure, traditional practice dictates that the mold portions are separated and the lens remains adhered to one of the mold portions. A release process detaches the lens from the remaining mold part.

It is known to form plastic mold parts used to manufacture ophthalmic lenses via injection molded. Generally, it is known to form such plastic mold parts by heating plastic resin and providing the melted resin via a hot runner to a mold apparatus. The melted resin is then forced into a mold to fashion a plastic mold part. Known methods utilize circulated water with a raised temperature of about 30° C. to 90° C., or more, to heat the mold used to fashion a plastic mold part. However, raising the molds to such high temperatures can slow the injection molding process and also be energy intensive.

Based on this physical behavior some advantages have been noted for using colder molds. However low mold temperatures also increase the amount of frozen-in stresses, orientations and otherwise heterogeneities in the material. These variations typically adversely affect part properties. Some of the negative effects can be part warpage, which can reduce the ability for an polymer mold to replicate the desired optical characteristics in the subsequent lens. Therefore, it would be advantageous to provide apparatus and methods which facilitate formation of a mold part with desirable characteristics via a process which includes cooling of a mold structure used to form the mold part while still maintaining good mold part quality and also providing manufacturing cycle time and energy conservation.

### SUMMARY OF THE INVENTION

Accordingly, the present invention provides methods and apparatus for facilitating ophthalmic lens mold manufacture via lower melt and mold temperatures as compared to that of the thin walled optical industry standard of between about 30° C. through 90° C. Specific embodiments can include ophthalmic lens mold manufacture with a lower mold temperature ranging from between about −10° C. to an upper mold temperature of about 28° C. or ambient temperature. In some preferred embodiments, ophthalmic lens mold manufacture is accomplished with a lower mold temperature ranging from between about 0° C. to an upper mold temperature of about 10° C.

### DESCRIPTION OF THE DRAWINGS

FIG. 1 illustrates a prior art diagram of an ophthalmic lens mold and lens.

FIG. 2 illustrates a block diagram of method steps that can be used to implement the present invention.

FIG. 3 illustrates a block diagram of apparatus that can be used to implement the present invention.

FIG. 4 illustrates a mold structure according to some implementations of the present invention.

FIG. 5 illustrates a chart indicating radius shrinkage of plastic mold parts.

### DETAILED DESCRIPTION OF THE INVENTION

The present invention relates generally to methods for improved formation of plastic molds used during manufacturing of ophthalmic lenses. In particular, the present invention includes enhanced injection molding processes and apparatus for implementing such processes for contact lens mold manufacture achieved through the use of melt and mold temperatures at the low end of the thin-walled optical industry standard. In some embodiments, heat transfer energy can be directed by, for example: Q=(weight per unit time)×(Material Specific Heat)×(Temperature Difference)

According to some embodiments of the present invention, lower mold tooling temperature results in an increased heat transfer rate between an injected molten polymer and the mold tooling. In some embodiments, the mold tooling temperature can be lowered to temperatures ranging from about −10° C. to ambient temperature with a preferred range of 0° C. to 10° C. Other embodiments can also include lower mold tooling temperatures. This increased transfer rate is beneficial for cycle time reduction and unexpectedly results in equal or better dimensional stability and surface replication. For example, the present invention results in reduced mold shrinkage, in particular for semi-crystalline materials, such as for example from approximately about 1% at room temperature to approximately about 0.65% at 10° C. One of the key components of optical mold for contact lenses is the ability to retain the designed radii for any meridian of the mold. Lowering the overall shrinkage of the material provides less opportunity for the mold to deviate from the designed radius.

Cold mold temperature processing and cooler melt temperature processing according to the present invention, also allows for the use of one or more of: semi-crystalline and amorphous materials in applications of contact lens manufacturing with fast cycle time and acceptable mold quality. Cold mold temperature processing also provides for a broad range of mold material selection which was previously considered less ideal or unacceptable for ophthalmic lens mold material applications

In some preferred embodiments, mold materials can include ExxonMobil PP9544MED® Polypropylene (9544) as base curve and NOVA Chemicals Polystyrene VEREX 1300® compounded with Zinc Stearate additive as front curve.

Alternate materials such as Zeonor and Zeonex by Zeon Chemical Corporation and polypropylene blends at variety of blending ratios can also be used, as can polyolefins, cyclic olefins and cyclic olefin copolymers, including, in some embodiments polyolefins and COCs compounded with additives. In some specific embodiments, examples can include, but are not limited to: PP9544 and polystyrene, 55% Zeonor and 45% polypropylene or polystyrene, 75% Zeonor and 25% polypropylene or polystyrene, 25% Zeonor and 75% polypropylene or polystyrene, 10% Zeonor and 90% polypropylene or polystyrene, 90% Zeonor and 10% polypropylene or polystyrene, 50% Zeonor and 50% polypropylene or polystyrene, and ExxonMobil PP 1654 E with the same above ratios.

These blended resins can be obtained using different compounding methods, including hand blending, single screw compounding, twin screw and/or multiple screw compounding.

In some embodiments, a minimum effective melt temperature is used to reduce the amount of heat in the polymer melt injected into a mold that is chilled below ambient temperature. In some preferred embodiments therefore, a melt temperature range for the mold plastic resin of about 225° C. to 260° C. is utilized for material such as ExxonMobil Polypropylene 9544 MED.

To achieve mold temperatures below ambient temperature, in some embodiments, a chilling device is utilized which chills water, or other liquid or gas, and circulates the chilled water through the mold tooling.

Defined Terms

As used herein “lens” or “ophthalmic lens” refers to any ophthalmic device that resides in or on the eye. These devices can provide optical correction or may be cosmetic. For example, the term lens can refer to a contact lens, intraocular lens, overlay lens, ocular insert, optical insert or other similar device through which vision is corrected or modified, or through which eye physiology is cosmetically enhanced (e.g. iris color) without impeding vision.

As used herein, the term “lens forming mixture” refers to a monomer or prepolymer material which can be cured, to form an ophthalmic lens. Various embodiments can include mixtures with one or more additives such as: UV blockers, tints, photoinitiators or catalysts, and other additives one might desire in an ophthalmic lenses such as, contact or intraocular lenses. Lens forming mixtures are more fully described below.

As used here, the term “mold part” refers to a plastic, rigid or semi-rigid object, that may be used to form lenses from uncured formulations.

As used herein, the term “uncured” refers to the physical state of a reaction mixture (sometimes referred to as “lens formulation”) prior to final curing to form a lens. Some reaction mixtures contain mixtures of monomers which are cured only once. Other reaction mixtures contain monomers, partially cured monomers, macromers and other components.

As used herein the term “lens forming surface” means a surface 103-104 that is used to mold a lens. In some embodiments, any such surface 103-104 can have an optical quality surface finish, which indicates that it is sufficiently smooth and formed so that a lens surface fashioned by the polymerization of a lens forming material in contact with the molding surface is optically acceptable. Further, in some embodiments, the lens forming surface 103-104 can have a geometry that is necessary to impart to the lens surface the desired optical characteristics, including without limitation, spherical, aspherical and cylinder power, wave front aberration correction, corneal topography correction and the like as well as any combinations thereof.

### Molds

In the formation of plastic molds that may be used to form lenses from uncured formulations, the preferred molds include two parts where either the front curve or the back curve part is formed in mold tooling which has been cooled to a temperature ambient to the mold tooling or less, prior to injection of molten material used to fashion the plastic mold part.

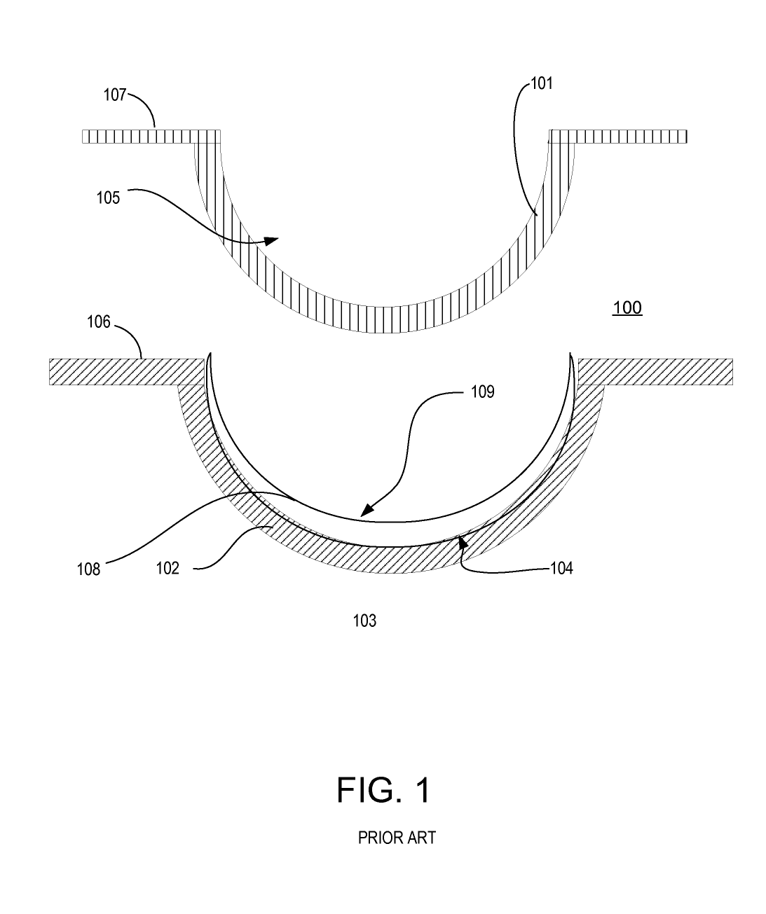

Referring now to FIG. 1, a diagram of an exemplary mold for an ophthalmic lens is illustrated. As used herein, the terms “mold” and “mold assembly” refer to a form 100 having a cavity 105 into which a lens forming mixture can be dispensed such that upon reaction or cure of the lens forming mixture, an ophthalmic lens 108 of a desired shape is produced. The molds and mold assemblies 100 of this invention are made up of two or more “mold parts” or “mold pieces” 101-102.

At least one mold part 101-102 is designed to have at least a portion of its surface 103-104 in contact with the lens forming mixture such that upon reaction or cure of the lens forming mixture that surface 103-104 provides a desired shape and form to the portion of the lens with which it is in contact. The same is true of at least one other mold part 101-102. The portion of the concave surface 104 which makes contact with reaction mixture has the curvature of the front curve of an ophthalmic lens to be produced in the mold assembly 100 and is sufficiently smooth and formed such that the surface of an ophthalmic lens formed by polymerization of the reaction mixture which is in contact with the concave surface 104 is optically acceptable.

Similarly, the back curve mold part 101 has a convex surface 103 in contact which contacts the lens forming mixture and has the curvature of the back curve of an ophthalmic lens to be produced in the mold assembly 100. The convex surface 103 is sufficiently smooth and formed such that the surface of an ophthalmic lens formed by reaction or cure of the lens forming mixture in contact with the back surface 103 is optically acceptable. Accordingly, the inner concave surface 104 of the front curve mold part 102 defines the outer surface of the ophthalmic lens, while the outer convex surface 103 of the back mold piece 101 defines the inner surface of the ophthalmic lens.

The mold parts 101-102 can be brought together, or “coupled”, such that a cavity is formed by combination of the mold parts 101-102 and a lens 108 can be fashioned in the cavity 105. This combination of mold parts 101-102 is preferably temporary. Upon formation of the lens, the mold parts 101-102 can again be separated for removal of a fashioned lens. FIG. 1 illustrates a back curve mold part 101 separated from a front curve mold part 102.

According to the present invention, mold tooling (sometimes referred to as a “mold structure”) used to fashion a mold part 101-102 is cooled below an ambient temperature of the mold structure and facilitates accelerated cooling of a material used to form the lens.

Some preferred embodiments include one or more of: COCs, alicyclic co-polymers and a polypropylene as a primary mold part material. In addition, in some embodiments, the molds of the invention may contain additives that facilitate the separation of the lens forming surfaces, reduce the adhesion of the cured lens to the molding surface, or both. For example, additives such as metal or ammonium salts of stearic acid, amide waxes, polyethylene or polypropylene waxes, organic phosphate esters, glycerol esters or alcohol esters may be added to alicyclic co-polymers prior to curing said polymers to form a mold. Examples of such additives can include, but are not limited, to Dow Siloxane MB50-001 or 321 (a silicone dispersion), Nurcrel 535 & 932 (ethylene-methacrylic acid co-polymer resin Registry No. 25053-53-6), Erucamide (fatty acid amide Registry No. 112-84-5), Oleamide (fatty acid amide Registry No. 301-02-0), Mica (Registry No. 12001-26-2), Atmer 163 (fatty alkyl diethanolamine Registry No.107043-84-5), Pluronic (polyoxypropylene-polyoxyethylene block co-polymer Registry No. 106392-12-5), Tetronic (alkyoxylated amine 110617-70-4), Flura (Registry No.7681-49-4), calcium stearate, zinc stearate, Super-Floss anti block (slip/anti blocking agent, Registry No. 61790-53-2), Zeospheres anti-block (slip/anti blocking agent); Ampacet 40604 (fatty acid amide), Kemamide (fatty acid amide), Licowax fatty acid amide, Hypermer B246SF, XNAP, polyethylene glycol monolaurate (anti-stat) epoxidized soy bean oil, talc (hydrated Magnesium silicate), calcium carbonate, behenic acid, pentaerythritol tetrastearate, succinic acid, epolene E43-Wax, methyl cellulose, cocamide (anti-blocking agent Registry No. 61789-19-3), poly vinyl pyrrolidinone (360,000 MW) and the additives disclosed in U.S. Pat. No. 5,690,865 which is hereby incorporated by reference in its entirety. The preferred additives are polyvinyl pyrrolidinone, zinc stearate and glycerol mono stearate, where a weight percentage of additives based upon the total weight of the polymers is about 0.05 to about 10.0 weight percent, preferably about 0.05 to about 3.0, most preferably about 2.0 weight percent.

In some embodiments, in addition to additives, the separation of the lens from a lens forming surfaces may be facilitated by applying surfactants to the lens forming surfaces. Examples of suitable surfactants include Tween surfactants, particularly Tween 80 as described in U.S. Pat. No. 5,837,314 which is hereby incorporated by reference in its entirety and Span 80. Other examples of surfactants are disclosed in U.S. Pat. No. 5,264,161 which is hereby incorporated by reference in its entirety.

Still further, in some embodiments, the molds of the invention may contain other polymers such as polypropylene, polyethylene, polystyrene, polymethyl methacrylate, modified polyolefins containing an alicyclic moiety in the main chain and cyclic polyolefins, such as, for example Zeonor and EOD 00-11 by Atofina Corporation. For example, a blend of the alicyclic co-polymers and polypropylene (metallocene catalyst process with nucleation, such as ATOFINA EOD 00-11(g)) may be used, where the ratio by weight percentage of alicyclic co-polymer to polypropylene ranges from about 99:1, to about 20:80 respectively. This blend can be used on either or both mold halves, however, in some embodiments, it is preferred that this blend is used on the back curve and the front curve consists of the alicyclic co-polymers.

In some embodiments, one or both of the first mold part 102 and the second mold part 101 may also include multiple layers, and each layer may have different chemical structures. For example, a front curve mold part 102 may include a surface layer and a core layer, (not illustrated) such that the core layer includes the first material and the second material and is essentially covered by the first layer. At any given cross section, a concentration of the first material present in the surface layer is greater than the concentration of the first material present in the core layer. To continue with the example, according to the present invention, the surface layer and also the core layer are cooled by a mold structure maintained at a temperature less than an ambient temperature.

### Method Steps

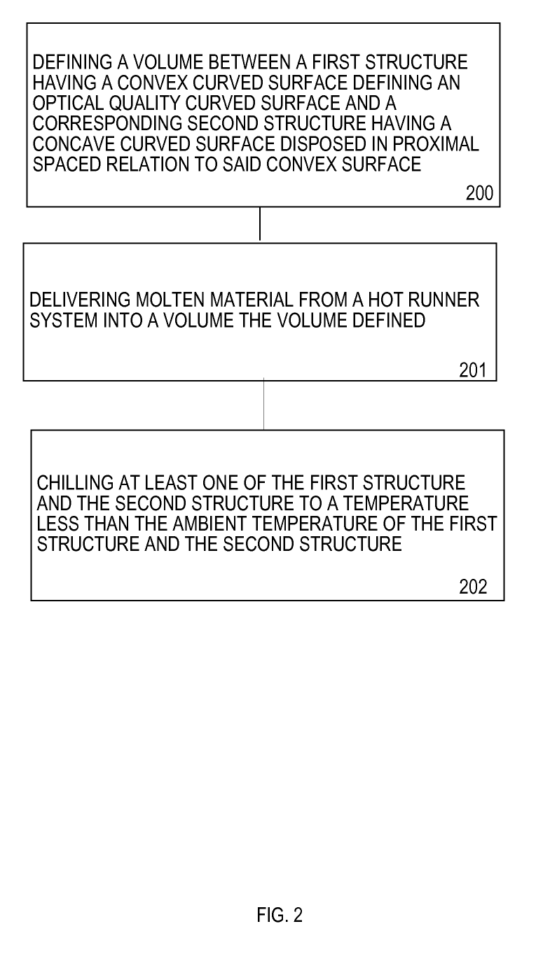

Referring now to FIG. 2, a flow diagram illustrates exemplary steps that may be implemented in some embodiments of the present invention. It is to be understood that some or all of the following steps may be implemented in various embodiments of the present invention.

At 200, a volume is defined between a first structure having a convex curved surface defining an optical quality curved surface and a corresponding second structure having a concave curved surface disposed in proximal spaced relation to said convex surface.

At 201, molten material is delivered from a hot runner system into a volume the volume defined.

At 202, at least one of the first structure and the second structure is chilled to a temperature less than the ambient temperature of the first structure and the second structure.

In some preferred embodiments, the molten material can include a polymer such as 9544 MED, 9494E1 polypropylenes from EXXON MOBIL, or HP370P from Basell which are Ziegler-Natta catalyzed grades. An additive package may also contain one or more of: a primary and secondary anti oxidant, an acid neutralizer and a nucleating agent.

Some embodiments may also utilize an injection molding machine and hot runner, such as, for example a SE50D Sumitomo electric injection molder.

Cooling time and holding time can be important parameters in a molding cycle. Typically they can be determined by heat exchange occurring between the polymer and the mold tooling. The cooling energy can be typically quantified by:

Q=(heat transfer coefficient of process)×Area×(log mean temperature difference between media)^{[1], [6], [8]} (1)

Molding of plastics, and, in some specific embodiments, polypropylene plastic, with a minimum stock temperature and a cold mold has previously been known to create warpage in the plastic mold part due to high internal stresses. According to the present invention previously known adverse effects have been overcome.

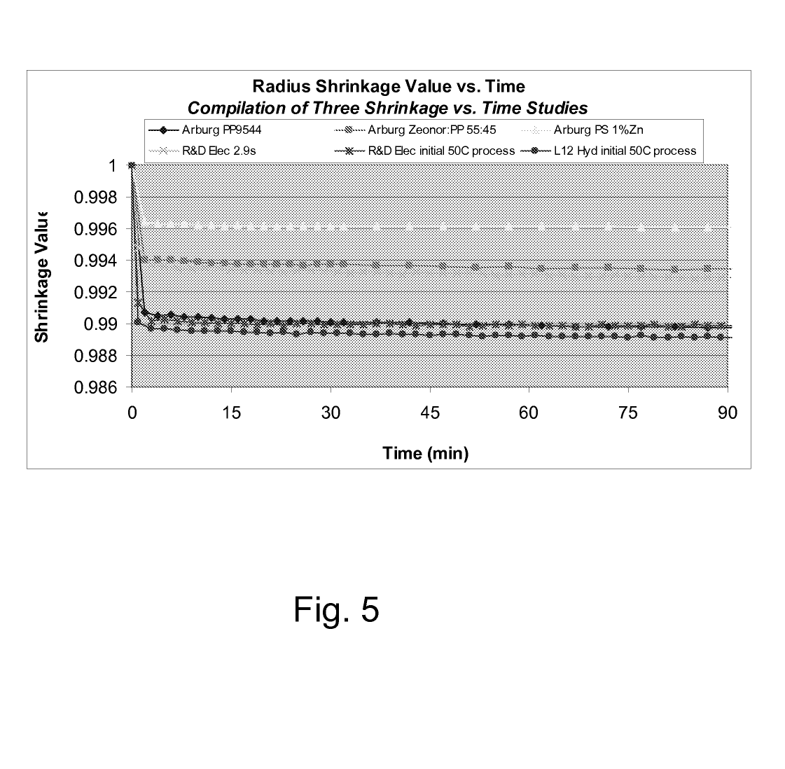

Referring now to FIG. 5, by way of a non-limiting example, the improvement demonstrated by the present invention may be better understood by examination of the effect of heat transfer on polypropylene. FIG. 5 displays the shrinkage versus time of polypropylene, polystyrene and 55/45 Zeonor/PP blend back curves. When molded at 50° C. the polypropylene plastic parts show approximately 1% shrinkage, which can be considered typical for this type of semi-crystalline material. Amorphous materials like polystyrene or the blend have a much lower overall shrinkage value. When molded in a 10° C. mold the polypropylene part exhibits a shrinkage reduction to 0.65%. This lower value is similar to that of a blend material. According to the present invention, the improvement is realized as the plastic is frozen rapidly into chilled molding structure. The chilled molding structure limits the time that polypropylene molecules have to crystallize and the resultant part will include more amorphous regions compared to that of a part molded at 50° C.

The mold average delta is expressed as a linear difference between the maximum and minimum mold radii on any meridian of a spherical design mold. It is associated to differential shrinkage in the flow and cross-flow direction of the mold. When the overall shrinkage of the plastic part is reduced, the opportunity to have high linear delta is also reduced. The reduction of linear delta for spherical product is a key factor to quality and is a measurement of the replication of the designed radius in the mold. It is expected that the invention also improves the replication of non spherical products by having a closer match to the designed radius, less influenced by flow and cross-flow shrinkage.

### Apparatus

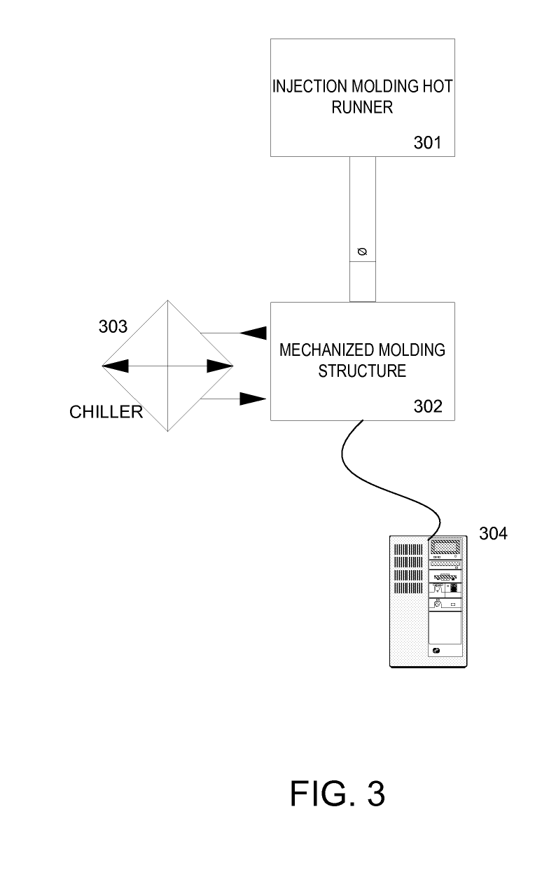

Referring now to FIG. 3, a block diagram is illustrated of apparatus contained in processing stations 301-304 that can be utilized in implementations of the present invention. In some preferred embodiments, an injection molding machine 301 is used to provide molten material, such as melted polypropylene to a mechanized molding structure 302 including a hot runner. Apparatus for chilling the injection molding 303 is used to lower the temperature of the molding structure 302 to below room temperature or other ambient temperature. In some particular embodiments, the temperature of the molding structure 302 is lowered to between negative 10° C. and 10° C. according to the parameters most useful in present day manufacturing environments. However, colder temperatures, which include a molding structure with a temperature less than −10° C. are within the scope of the present invention.

A computerized controller 304 may be operative via executable software to control the functionality of the injection molding machine and hot runner 301, the mechanized molding structure 302 and the chiller 303.

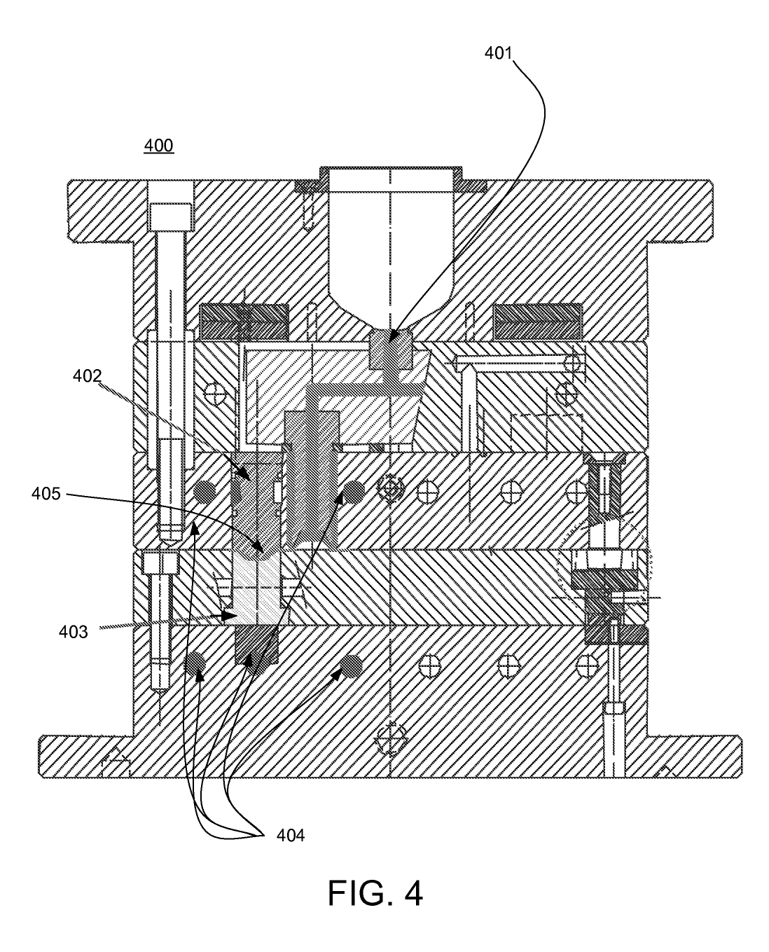

Referring now to FIG. 4, an exemplary molding structure 400 useful in implementations of the present invention is illustrated. The molding structure 400 can include a hot runner 401 which provides molten material, such as, for example, molten polypropylene, to a mold structure. The mold structure can include, for example, at least one first structure having a convex curved surface 402 defining an optical quality curved surface and at least one corresponding second structure having a concave curved surface 403 disposed in proximal spaced relation to the convex surface 403, said first and second structures defining therebetween a volume 405 wherein a plastic mold part is formed.

The mold structure also includes cooling channels 404 through which a chilled liquid or gas may be circulated in order to maintain the mold structure 400 and in particular cooling one or more of the first structure having a convex curved surface 402 and corresponding second structure having a concave curved surface 403 to a temperature which is less than ambient temperature and preferably between −10° C. and 10° C.

### EXAMPLES

As indicated in Table 1, Table 2 and Table 3 below, experiments revealed that when using either polypropylene material or a Zeonor 1060R/polypropylene blend, lowering the temperature of the mold led to superior dimensional stability of the parts. In some embodiments, improvement in dimensional stability is attributed to a variation in polypropylene morphology that provides a desirable dimensional constancy. The use of a mold with a water temperature inlet of 10° C. or below in conjunction to 9544MED allowed to produce polymer molds with good mold quality at cycle times reduced compared to higher mold temperatures.

TABLE 1

| | BC Radius | | | | | BC Delta | | | |
|---|---|---|---|---|---|---|---|---|---|
| | 25 C. | 30 C. | 35 C. | 40 C. | | 25 C. | 30 C. | 35 C. | 40 C. |
| Std Deviation | 0.004 | 0.003 | 0.004 | 0.004 | Average | 0.015 | 0.016 | 0.017 | 0.017 |

TABLE 2

| | | Process 1 | Process 2 |
|---|---|---|---|
| CYCLE TIME | sec. | 2.9 | 2.8 |
| Mold Temp. (A- and B-side) | deg C. | 10 | 7 |
| Hold Time (1st/2^{nd}/3rd/4th) | sec. | 1 | 0.9 |
| Radius Std. Dev | μm | 0.0055 | 0.0054 |
| Average Delta | μm | 0.018 | 0.014 |

TABLE 3

| Mold Temp | BC Avg Delta | BC Delta Std Dev |
|---|---|---|
| 5 | 0.012 | 0.008 |
| 10 | 0.011 | 0.005 |
| 15 | 0.015 | 0.012 |
| 20 | 0.015 | 0.009 |
| 25 | 0.016 | 0.011 |

While the present invention has been particularly described above and drawings, it will be understood by those skilled in the art that the foregoing ad other changes in form and details may be made therein without departing from the spirit and scope of the invention, which should be limited only by the scope of the appended claims.

What is claimed is:

1. A molding apparatus for producing at least one mold half which is used for subsequently molding a soft contact lens therewith, comprising:
at least one first structure having a convex curved surface defining an optical quality curved surface;
at least one corresponding second structure having a concave curved surface disposed in proximal spaced relation to said convex surface, said first and second structures defining therebetween a volume wherein a mold half is formed;
a runner system connected to the volume between said first and second structures for delivering a quantity of molten material of which the mold half is to be formed;
a chilling apparatus for chilling a coolant liquid to a temperature below ambient temperature of the molding apparatus; and
fluid communication apparatus for communicating coolant chilled below ambient temperature from the chilling apparatus to at least one of said first and second structures, wherein the chilled coolant provides for faster cooling of molten material which forms the mold half at the optical quality surface and also provides faster mold cycling time.

2. The apparatus of claim 1 wherein said optical quality curved surface of said first structure being positioned further away from said hot runner system than said concave curved surface of said at least one second structure, such that the subsequently molded mold half comprises a concave optical quality lens forming surface

3. The molding apparatus of claim 1 wherein said chilling apparatus comprises a coolant circulator operative to create a turbulent flow mode through the molding structure.

4. The molding apparatus of claim 1 wherein the coolant is chilled to a temperature of between about 5° C. and about 20° C.

5. The molding apparatus of claim 1 wherein the coolant is chilled to a temperature of between about 8° C. and about 12° C.

6. The molding apparatus of claim 1 wherein the coolant is chilled to a temperature of between about −10° C. and about 10° C.

7. The molding apparatus of claim 1 wherein the coolant is chilled to a temperature of below about 0° C.

8. The molding apparatus set forth in claim 6, wherein the molding arrangement includes a plurality of first and second structures for simultaneously producing a plurality of mold halves.

9. The molding apparatus of claim 8 wherein the hot runner system delivers the molten plastic to said first and second structures at a temperature of between about 185° C. to 260° C.

10. A method for producing at least one mold half which is used for subsequently molding a soft contact lens therewith, the method comprising:
defining a volume between a first structure having a convex curved surface defining an optical quality curved surface and a corresponding second structure having a concave curved surface disposed in proximal spaced relation to said convex surface;
delivering molten material from a runner system into the volume defined; and
prior to the delivery of the molten material, chilling at least one of the first structure and the second structure to a temperature less than the ambient temperature of the first structure and the second structure.

11. The method of claim 10 wherein the at least one of the first structure and the second structure chilled below ambient temperature is chilled at least in part by bringing a coolant liquid chilled to a temperature below the ambient temperature of the first and second structures into thermal communication with at least one first structure and the second structure.

12. The method of claim 11 wherein the molten material comprises polypropylene and the chilled coolant provides for faster cooling of polypropylene and thereby prevents complete crystallization of the polypropylene.

13. The method of claim 10 wherein the runner system comprises a hot runner system.

14. The method of claim 10 wherein the runner system comprises a cold runner system.

15. The method of claim 10 wherein the runner system delivers the molten plastic to said first and second structures at a temperature of between about 185° C. to 260° C.

16. The method of claim 11 wherein the coolant is chilled to a temperature of between about −10° C. and about 10° C.

17. The method of claim 11 wherein the coolant is chilled to a temperature of below about 0° C.

18. A method of manufacturing an ophthalmic lens, the method comprising the steps of:
defining a volume between a first structure having a convex curved surface defining an optical quality curved surface and a corresponding second structure having a concave curved surface disposed in proximal spaced relation to said convex surface;
delivering molten material from a runner system into the volume defined;
prior to the delivery of the molten material, chilling at least one of the first structure and the second structure to a temperature less than the ambient temperature of the first structure and the second structure;
forming at least one mold part with a lens forming surface;
cast molding an ophthalmic lens with a lens forming mixture in contact with the lens forming surface on the at least one mold part.

19. The method of claim 18 wherein the lens forming mixture comprises siloxane.

20. The method of claim 18 wherein the lens forming mixture comprises a silicone hydrogel.
